(19) United States
(12) Patent Application Publication
(10) Pub. No.: US 2006/0166644 A1
(43) Pub. Date: Jul. 27, 2006

(54) Distributed GPS traffic information system

(76) Inventor: Mark A. Champion, Kenmore, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/043,855

(22) Filed: Jan. 25, 2005

(51) Int. Cl. H04B 7/15

(52) U.S. Cl. 455/406

(57) ABSTRACT

An embodiment of the present invention includes a technique to use distributed traffic information. A communication device is connected to a center via a wireless connection. The communication device receives global positioning system (GPS) information. The center is communicated with via the communication device using the GPS information to report a traffic condition at a vicinity of a location.

### BACKGROUND

1. Field of the Invention

Embodiments of the invention relates to the field of Global Positioning System (GPS) information, and more specifically, to distributed GPS information system.

2. Description of Related Art

Information regarding traffic conditions is especially useful in many aspects. Government agencies may use the information for planning, improvement, and development of effective highway infrastructure. Insurance companies may use the information to determine costs of insurance and premiums. Areas that are highly congested tend to cause more accidents than those that are not. Consumers may use the information to plan for their daily commute.

Existing techniques to provide traffic information have a number of drawbacks. One popular technique is to install sensors or cameras at various locations along the highways, streets, or roads. The sensors or cameras send data or pictures to a center for analysis and reporting. This technique is costly. A large number of sensors or cameras have to be installed to achieve a reasonable accuracy. This would lead to high start-up cost in addition to maintenance and upgrade costs. It is also slow because the data or pictures have to be analyzed manually and require experienced analysts. It is also not useful. The information may provide only certain aspects of the traffic conditions such as whether or not there is a collision or accident. Another technique is to obtain information as reported by traffic news reporters, usually from news helicopters flying along a highway during rush hours. This technique does not provide complete information of many areas at any time. It may also not be reliable because the news reporter does not always have a clear view of what is happening on the highway or the surface streets.

### BRIEF DESCRIPTION OF THE DRAWINGS

Embodiments of the invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating a communication message according to one embodiment of the invention.

FIG. 3 is a diagram illustrating a distributed information model according to one embodiment of the invention.

FIG. 4 is a flowchart illustrating a process to communicate with the center by a subscriber according to one embodiment of the invention.

FIG. 5 is a flowchart illustrating a process to communicate with a subscriber by the center according to one embodiment of the invention.

### DESCRIPTION

An embodiment of the present invention includes a technique to use distributed traffic information. A communication device is connected to a center via a wireless connection. The communication device receives global positioning system (GPS) information. The center is communicated with via the communication device using the GPS information to report a traffic condition at a vicinity of a location.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a program, a procedure, a method of manufacturing or fabrication, etc.

A preferred embodiment of the invention is a technique to provide information for traffic condition using GPS information. A traffic information system includes a center and subscribers. A subscriber in a vehicle moving in a traffic area reports the traffic condition of the area to the center using a GPS-enabled communication device such as a cellular phone. The GPS-enabled communication device automatically sends the GPS information including location and time to the center via an automatic message. The velocity of the vehicle may also be computed by the communication device and included in the automatic message. The center obtains the location and time data and/or velocity from the automatic message and determines the traffic condition in the reported area. By collecting such information from a number of subscribers, the center can have reliable traffic information that can be distributed to other people, such as other subscribers or participants in the system. Other embodiments of the invention include transmission of the GPS information or other ancillary information related to the traffic condition by the subscriber using other types of messages such as voice, textual, or images.

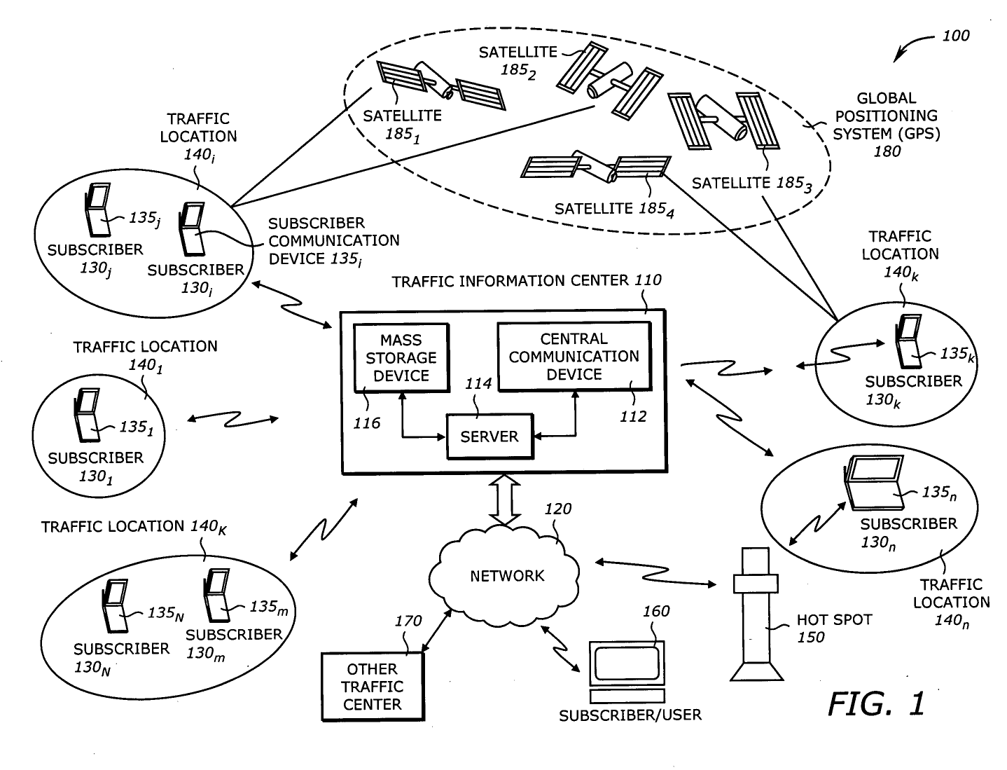

FIG. 1 is a diagram illustrating a system 100 in which one embodiment of the invention can be practiced. The system 100 includes a traffic information center 110, a network 120, N subscribers 130₁ to 130_{N}, K traffic regions 140₁ to 140_{K}, where N and K are positive integers, a hot-spot 150, a subscriber/user 160, another traffic center 170, and a Global Positioning System (GPS) 180. Note that the system 100 may include more or less than the above elements.

The traffic information center 110 receives traffic information from the N subscribers 130₁ to 130_{N} and transmits the received traffic information to those subscribers who request information. The traffic information is received and transmitted in real-time. Therefore, the information is constantly updated and reflects the most current traffic condition. The center 110 includes a central communication device 112, a server 114, and a mass storage device 116. The central communication device 112 may be any device that can communicate with any one of the subscriber communication devices by wireless connection. Examples of the central communication device 112 are a network device, a computer (e.g., desktop, notebook, laptop), etc. The central communication device 112 may be controlled by a machine or a human operator. The server 114 includes a processing unit to process the information. The processing unit is typically a microprocessor, a computer, or a processor capable of executing program instructions. It may contain a memory to store program, code, or data that, when accessed by the processing unit, causes the processing unit to perform operations as described below. It is connected to the network 120 to transmit or receive data or information through the network 120. The mass storage device 116 stores archive information such as code, programs, files, data, applications, and operating systems. The mass storage device 116 may include electronic disk (e.g. flash), a compact disk (CD) ROM, a digital video/versatile disc (DVD), floppy drive, and hard drive, and any other magnetic or optic storage devices. The mass storage device 116 provides a mechanism to read machine-accessible media. The machine-accessible media may contain computer readable program code to perform tasks as described above.

The network 120 is any network that may transmit communication messages among participants such as the center 110, any one of the N subscribers 130₁ to 130_{N}, subscriber/user 160, and other traffic center 170. The network 120 may be a local area network (LAN), a wide area network (WAN), the Internet, an intranet, an extranet, etc.

The N subscribers 130₁ to 130_{N} are participants in the traffic information system administered by the center 110. Each of the N subscribers 130₁ to 130_{N} communicates with the center 110 via a subscriber communication device 135ᵢ such as a cellular phone, a PDA, a navigation unit, a computer, a network device. In one embodiment, the subscriber communication device 135 is capable of receiving Global Positional System (GPS) information and transmitting the GPS information. The GPS information is used by the traffic information center to determine the traffic condition. The subscribers 130₁ to 130_{N} are registered as providers or users of the traffic information. As information providers, they are individuals who provide information on traffic conditions at various traffic locations. Typically, they are drivers actually driving in traffic at the vicinity of the location for which their GPS enabled communication device automatically reports the traffic condition. Essentially, they act as dynamic sensors that report the flow of traffic. The information provided by them is therefore very accurate and reflects the most updated condition. As information users, they request information regarding traffic condition at a particular location, and receive the information from the center as provided by other information providers. A subscriber may be both a provider and a user at the same time. For example, a subscriber while driving through a location may report the traffic condition at that location. He or she may then request information on the traffic condition at another location, perhaps to plan for his or her route accordingly.

Depending on the business model offered by the center, the information providers may receive a compensation for providing the information, and the information users may pay a compensation to the center for using the information. The compensation may be in any suitable form. It may be in a form of a monetary payment, a credit for providing the information, a credit for a service, a debit for using the information, etc. Alternatively, the subscribers may pay a membership fee to participate in the system, either as a provider or a user.

The traffic locations 140₁ to 140_{K} are areas that cover the locations where the subscribers are located. They are typically fixed and occupy a designated area according to the traffic map. While the subscribers 130₁ to 130_{N} are dynamic, moving in and out of the traffic locations 140₁ to 140_{K}, the traffic locations are constant.

The hot-spot 150 is a wireless fidelity (Wi-Fi) location that offers wireless communication to the subscribers. It is typically located at highly popular places such as airports, hotels, convention centers, etc. As Wi-Fi technology expands, there may be several hot-spots located along highways or streets. A subscriber may use a computer or a PDA with Wi-Fi compatibility to communicate with the center 110 via the network 120.

The subscriber/user 160 is an individual, a business entity, or any service that subscribes to or participates in the information system provided by the center 110. The subscriber/user 160 communicates with the center 110 via the network 120. For example, the subscriber/user 160 may access the Website of the center 110 to view the traffic conditions at various locations in the area.

The other traffic center 170 is any other traffic information center that receives the traffic information provided by the center 110. It may be a private organization or a government agency. The other traffic center 170 may also exchange the traffic information with the center 110. Each center may use the information provided by the other to verify or confirm the reliability or accuracy of its own information.

The GPS 180 is a satellite navigation system that provides accurate position of a GPS receiver. The nominal GPS operational constellation consists of 24 satellites that orbit around the earth. There are typically four satellites 185₁ through 185₄ in user segment to provide position (X,Y,Z coordinates) and the time. The GPS positioning services provided by the United States radio-navigation plan include precise positioning service (PPS) and standard positioning service (SPS). The PPS predictable accuracy includes 22 meter horizontal accuracy, 22.7 meter vertical accuracy, and 200 nanosecond time accuracy. The SPS predictable accuracy includes 100 meter horizontal accuracy, 156 meter vertical accuracy, and 340 nanoseconds time accuracy. The Wide Area Augmentation System (WAAS) provides GPS corrections to provide better position accuracy. Commercial GPS receivers may now have position accuracy of less than 3 meters 95% of the time. The accuracies provided by the WAAS-capable receivers are acceptable for traffic information.

The GPS information provides the location and the time of a subscriber who travels through a traffic area. Many communication devices now have capability to have GPS information. Examples of these devices include cellular phones or automobile navigation systems. A subscriber may obtain this information and transmits to the center 110 to register his or her location when he or she reports the traffic condition to the center 110. By having the GPS location and time information, the center 110 may have accurate data regarding the traffic condition at a particular location at a particular time. Since the information is real-time, the traffic condition is updated with the most recent information.

Traffic condition may be characterized by the average speed of vehicles in the traffic area. The GPS information includes location information and time. The location information include the longitudinal and latitudinal information which may be converted to the (x,y,z) coordinates. Knowing the (x,y,z) coordinates at two time instants t₁ and t₂, an instantaneous velocity may be computed. When the time difference between t₁ and t₂ is sufficiently large (e.g., fifteen seconds), an average velocity may be computed. Furthermore, the more information providers send the GPS information within the vicinity of a traffic area, the more accurate the computed average velocity in that vicinity. The velocity may be computed by the subscriber communication device or the center.

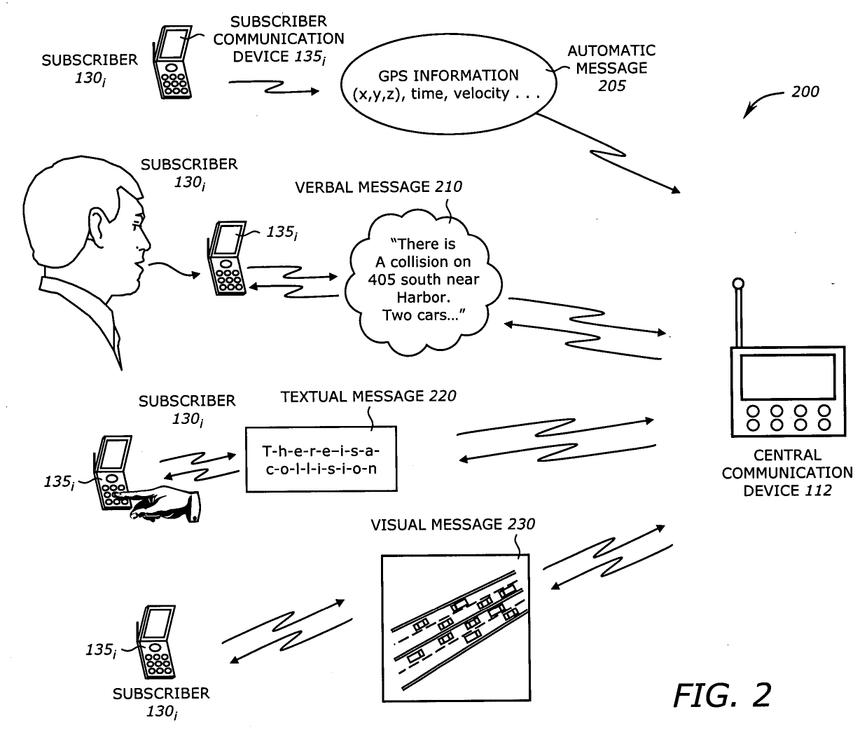

FIG. 2 is a diagram illustrating a communication message 200 according to one embodiment of the invention. The communication message 220 is used by the subscribers and the center 110 to communicate with each other. There are four types of communication message 200: an automatic message 205, a verbal message 210, a textual message 220, and a visual message 230. The communication message 220 may be any one of the above four types or any combination of four types.

The automatic message 205 is the message that is automatically sent and/or encoded for a specific function. It may be used to transmit GPS information or a request for traffic condition. It may contain the location and time as received from the GPS system. It may also include the velocity as computed from the location and time information by the subscriber communication device. Typically the automated message 205 is transmitted automatically after the functionality is enabled. The transmission may be periodic over some pre-defined interval (e.g., every 30 seconds). The interval may be fixed or programmable by the information provider. Alternatively, it may be transmitted only when the information provider activates the functionality such as pressing a button on the communication device 135. The automatic message 205 may be sent directly and/or automatically from the subscriber communication device 135 (e.g., a GPS-enabled cell phone) to the central communication device 112. Alternatively, it may be sent from one subscriber communication 135 (e.g., a GPS-enabled cell phone) to another (e.g., a computer or a PDA) before sending to the central communication device 112.

The verbal message 210 is a spoken message either by human being or by a speech synthesizer. The subscriber 130ᵢ may call the center 110 using his cellular phone and speaks to the mouthpiece of the cellular phone. The center 110 may receive the verbal message 210 through the central communication device 112 alone or a human operator using the central communication device 112. The verbal message 210 may then be transcribed and translated into computer-readable data to be fed into an information analysis system. Similarly, the center 110 may also transmit a verbal message to the subscriber 130₁. This can be a message generated by a speech synthesizer or by a human operator.

The textual message 220 consists of textual information. It can be coded according to some pre-defined format to facilitate machine processing, or it can be any textual message about the traffic condition. It can be parsed or analyzed by the information analysis system. The subscriber 130ᵢ may enter the textual message using buttons or keyboard on his or her communication device such as the keypad buttons on the cellular phone or the keyboard on the PDA or the computer. Similarly, the center 110 may send a textual message to the subscriber. The textual message can be displayed on the subscriber's cellular phone or computer.

The visual message 230 is a picture or image of the traffic. The subscriber 130ᵢ may take a picture of the actual scene of the traffic at his location and send it to the center 110. Since most cellular phones have a built-in camera, the subscriber 130ᵢ can readily use the camera and takes a snap-shot of the traffic. The visual message 230 sent to the center 110 may then be analyzed, either by a machine or a human analyst, or used without analysis. Similarly, the center 110 may send a visual message to the subscriber 130ᵢ. The visual message may contain an annotated map of the location and/or message(s) regarding the traffic condition. The image of the traffic at a specified location can be displayed on the subscriber's cellular phone, PDA, or computer.

The subscriber 130 may use any one of the above types of messages or any combination of them. For example, he may activate his cellular phone to periodically transmit the GPS information and attach a picture of the scene. Similarly, the center 110 may also use any one of the above types of messages or any combination of them.

The communication message 200 may be one of a series of messages exchanged between the subscriber 130 and the center 110. The communication regarding the traffic condition may follow a pre-determined format. It may consist of a series of responses entered by the subscriber when he or she reports the traffic condition. The traffic condition may also be coded to facilitate the responses. For example, it may be coded by numbers to designate the traffic condition as no congestion, light congestion, medium congestion, or heavy congestion. The subscriber may also enter his or her average speed at the time or the average velocity may be automatically computed by the communication device as part of the GPS information to be sent to the center.

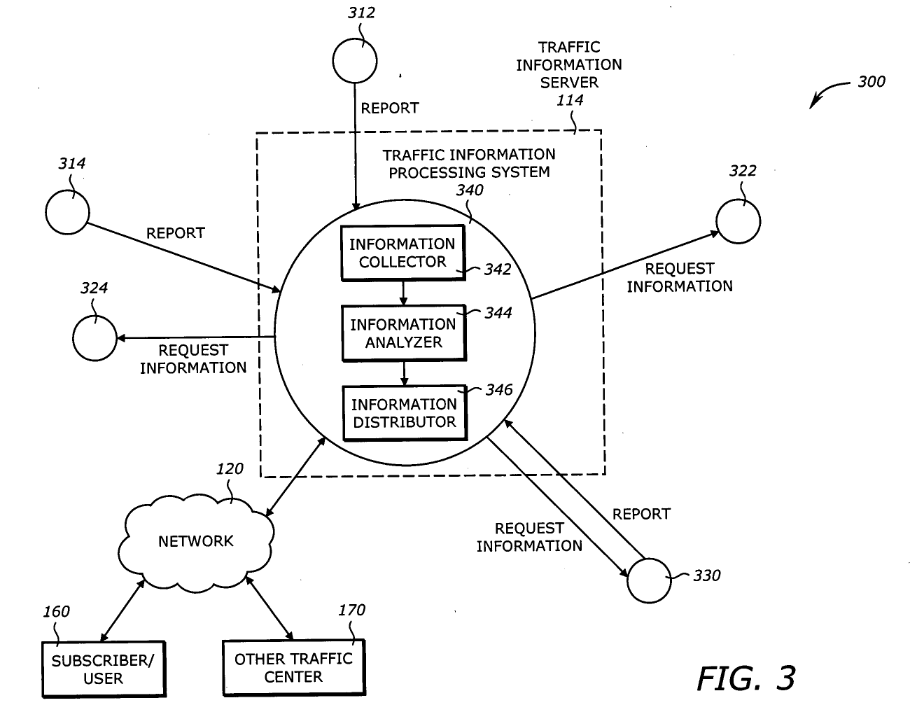

FIG. 3 is a diagram illustrating a distributed information model 300 according to one embodiment of the invention. The model 300 depicts a distributed traffic information system where the subscribers report information or request information. For illustrative purposes, the model 300 includes subscribers 312, 314, 322, 324, and 330, and the traffic information processing system 320 located in the server 114 of the center 110.

The subscribers 312, 314, 322, 324, and 330 are located at various locations throughout the coverage area. As discussed earlier, these subscribers are dynamic. They may enter and exit a particular traffic area. They may participating in or leave the information gathering process at any time in a random fashion. The subscribers 312, 314, and 330 are information providers who report the traffic condition. The subscribers 322, 324, and 330 are information users who request for information on the traffic condition at specified locations. Note that the subscriber 330 is both an information provider and an information user.

The traffic information processing system 340 collects, analyzes, and distributes the traffic information continuously and dynamically. The traffic information processing system 340 is typically software or a program executed by the processing unit in the server 114 (FIG. 1). It includes an information collector 342, an information analyzer 344, and an information distributor 346.

The information collector 342 collects the traffic information as provided by the subscribers 312, 314, and 330. It may also collect information from the subscriber/user 160 and the other traffic center 170 through the network 120. The information is spatially and temporally distributed. The information collector 342 may perform some data reduction or pre-processing to reduce the amount of information to relevant data. It may also organize or sort the information into useful data. It may also transform, extract, and convert the different information formats into a unified format that can be analyzed by the information analyzer 344. The information may be checked for consistency. For example, when receiving conflicting information regarding a particular location, it may put aside the conflicting information until it can verify later, perhaps by more information, or perhaps by checking the reliability score of the subscribers who report the conflicting information.

The information analyzer 344 analyzes the collected information as pre-processed by the information collector 342. The analysis may be performed by a processor, a machine, or a human analyst, or a combination of both. The information analyzer 344 may compute the average velocity of a traffic area based on the independent reports transmitted by the information providers. The computations may include operations such as data smoothing, extrapolation, or interpolation to provide accurate and realistic results. In addition, the information analyzer 344 may generate inferences or conclusions based on the data provided by the information collector 342. For example, if the report from subscriber 312 indicates heavy congestion at a location on a southbound freeway during a non-rush hour, and the report from subscriber 314 indicates medium congestion at the same location on a northbound freeway at the same time, the information analyzer 344 may infer that there is an accident at the location on the southbound freeway. The information analyzer 344 may be implemented as an inference engine with pre-defined rules such as If . . . Then . . . Else rule. Each rule is fired if the conditions for the rule are met, i.e., when the If condition is met. A fired rule may provide an input to another rule until a final rule is reached. An example of such a rule is “If there are more than 10 reports of heavy congestion at the same location within a 200-meter radius and 10 minutes, Then, there is a traffic accident at that location.” Any other inference or analysis techniques may be used. The objective is to extract useful and relevant information from the raw information as provided by the information collector 342.

The information distributor 346 distributes the analyzed information or the raw information collected by the information collector 342 to the subscribers or users or other traffic centers. The distribution may be in any suitable form such as an information bulletin posted on the Website of the center 110 for public viewing or for registered viewer. The analyzed information may also be distributed or transmitted to a server of another traffic information center.

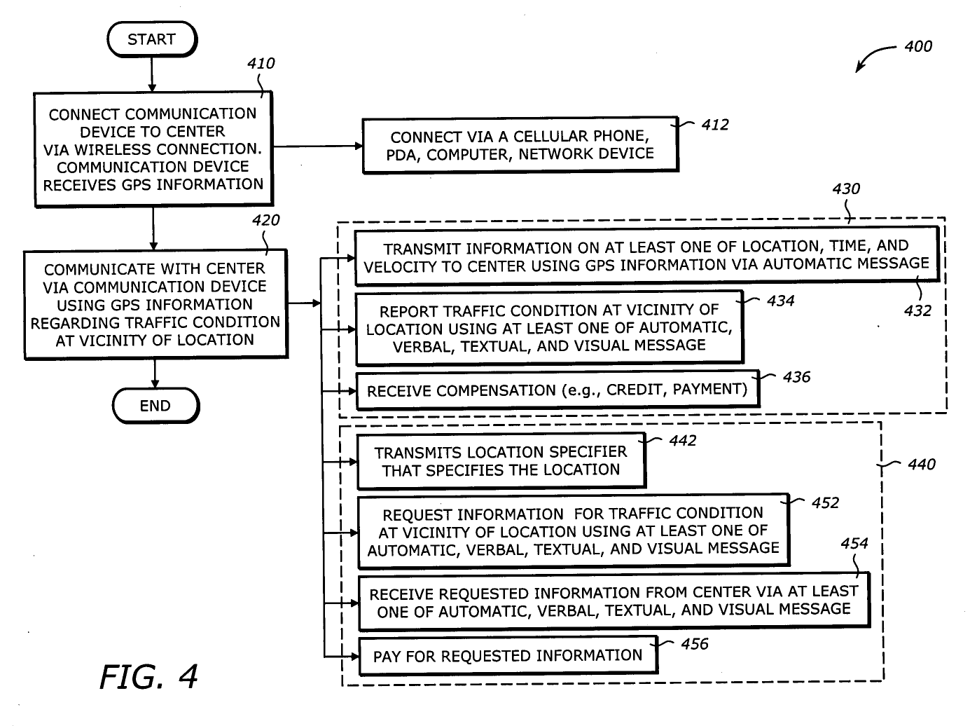

FIG. 4 is a flowchart illustrating a process to communicate with the center by a subscriber according to one embodiment of the invention.

Upon START, the process 400 connects a subscriber communication device to a center via a wireless connection (Block 410). The communication device may be one of a cellular phone, a PDA, a computer, or a network device (Block 412). Next, the process 400 communicates with the center via the central communication device reporting vehicle velocity and location (Block 420). The vicinity is defined as an area that is close to the location within some reasonable distance.

The communication depends on whether the subscriber is an information provider or an information user. If the subscriber is an information provider, the process 400 communicates using operations in Block 430. In Block 430, the process 400 transmits information on at least one of location, time, and velocity to the center using GPS information via an automatic message (Block 432). The GPS information is used to infer traffic conditions such as average vehicle speed. Then, the process 400 optionally reports additional information on the traffic condition at a vicinity of the location using at least one of an automatic, verbal, textual, or visual message (Block 434). Optionally, the process 400 receives compensation for the reported traffic condition (Block 436). The compensation may be one of a credit for receiving information on the traffic condition, a payment, and a credit for a service, or any other suitable type of compensation as agreed upon between the subscriber and the center.

If the subscriber is an information user, then the process 400 communicates using operations in Block 440. In Block 440, the process 400 transmits the location specifier that specifies the location (Block 442). Next, the process 400 requests information for the traffic condition at the vicinity of the location using at least one of an automatic, verbal, textual, and visual message (Block 452). Then, the process 400 receives the requested information from the center via at least one of an automatic, verbal, textual, and visual message (Block 454). Next, the process 400 optionally pays for the requested information (Block 456).

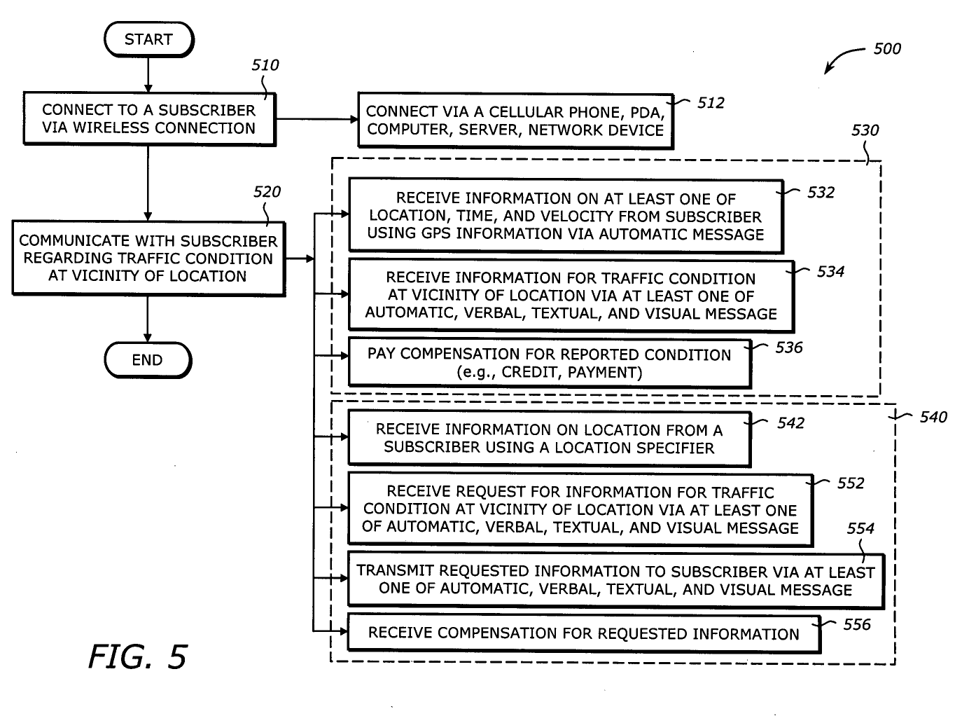

FIG. 5 is a flowchart illustrating a process 500 to communicate with a subscriber by the center according to one embodiment of the invention.

Upon START, the process 500 connects the central communication device to a subscriber communication device via a wireless connection (Block 510). The subscriber and/or central communication device may be one of a cellular phone, a PDA, a computer, a server, or a network device (Block 512). Next, the process 500 communicates with the subscriber via the communication device regarding traffic condition at a vicinity of a location (Block 520). The vicinity is defined as an area that is close to the location within some reasonable distance.

The communication depends on whether the subscriber is an information provider or an information user. If the subscriber is an information provider, the process 500 communicates using operations in Block 530. In Block 530, the process 500 receives information on at least one of location, time, and velocity from the subscriber via an automatic message (Block 532). Then the process 500 optionally receives additional information on the traffic condition at a vicinity of the location via at least one of an automatic, verbal, textual, or visual message (Block 534). Optionally, the process 500 pays a compensation for the reported traffic condition (Block 536). The compensation may be one of a credit for receiving information on the traffic condition, a payment, and a credit for a service, or any other suitable type of compensation as agreed upon between the subscriber and the center.

If the subscriber is an information user, then the process 500 communicates using operations in Block 540. In Block 540, the process 500 receives information on the location from the subscriber using a location specifier (Block 542). Next, the process 500 receives a request for information for the traffic condition at the vicinity of the location via at least one of an automatic, verbal, textual, and visual message (Block 552). Then, the process 500 transmits the requested information to the subscriber via at least one of an automatic, verbal, textual, and visual message (Block 554). Next, the process 500 optionally receives compensation for the requested information (Block 556).

Elements of one embodiment of the invention may be implemented by hardware, firmware, software or any combination thereof. The term hardware generally refers to an element having a physical structure such as electronic, electromagnetic, optical, electro-optical, mechanical, electromechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc that is implemented or embodied in a hardware structure (e.g., flash memory, ROM, EPROM). Examples of firmware may include microcode, writable control store, microprogrammed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable programmable ROM (EPROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described above. The machine accessible medium may also include program code embedded therein. The program code may include machine readable code to perform the operations described above. The term “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
connecting a communication device to a center via a wireless connection, the communication device receiving global positioning system (GPS) information; and
communicating with the center via the communication device using the GPS information to report a traffic condition at a vicinity of a location.

2. The method of claim 1 wherein connecting comprises
connecting the communication device to the center using one of a cellular phone, a personal digital assistant (PDA), a computer, and a network device.

3. The method of claim 1 wherein communicating comprises:
transmitting information on at least one of location, time, and velocity to the center using the GPS information.

4. The method of claim 1 wherein communicating comprises:
reporting the traffic condition at the vicinity of the location using at least one of an automatic message, a verbal message, a textual message, and a visual message, the automatic message containing the GPS information.

5. The method of claim 1 wherein communicating comprises:
requesting information for the traffic condition at the vicinity of the location using at least one of an automatic message, a verbal message, a textual message, and a visual message; and
receiving the requested information from the center via at least one of an automatic message, a verbal message, a textual message, and a visual message.

6. The method of claim 3 further comprising:
receiving a compensation for the reported traffic condition.

7. The method of claim 6 wherein receiving the compensation comprises:
receiving the compensation being one of a credit for receiving information on the traffic condition, a payment, and a credit for a service.

8. The method of claim 4 further comprising:
paying for the requested information.

9. A method comprising:
connecting to a subscriber via a wireless connection; and
communicating with the subscriber regarding a traffic condition at a vicinity of a location.

10. The method of claim 9 wherein connecting comprises
connecting to the subscriber using one of a cellular phone, a personal digital assistant (PDA), a computer, a server, and a network device.

11. The method of claim 9 wherein communicating comprises:
receiving information on at least one of location, time, and velocity from the subscriber using global positioning system (GPS) information.

12. The method of claim 9 wherein communicating comprises:
receiving information for the traffic condition at the vicinity of the location via at least one of an automatic message, a verbal message, a textual message, and a visual message, the encoded message containing global positioning system (GPS) information.

13. The method of claim 9 wherein communicating comprises:
receiving a request for information for the traffic condition at the vicinity of the location via at least one of an automatic message, a verbal message, a textual message, and a visual message; and
transmitting the requested information to the subscriber via at least one of an automatic message, a verbal message, a textual message, and a visual message.

14. The method of claim 11 further comprising:
paying a compensation for the reported traffic condition.

15. The method of claim 14 wherein paying the compensation comprises:
paying the compensation being one of a credit for receiving information on the traffic condition, a payment, and a credit for a service.

16. The method of claim 12 further comprising:
receiving a compensation for the requested information.

17. An article of manufacture comprising:
a machine-accessible medium including data that, when accessed by a machine, causes the machine to perform operations comprising:
connecting to a subscriber via a wireless connection; and
communicating with the subscriber regarding a traffic condition at a vicinity of a location.

18. The article of manufacture of claim 17 wherein the data causing the machine to perform connecting comprises data that, when accessed by the machine, causes the machine to perform operations comprising:
connecting to the subscriber using one of a cellular phone, a personal digital assistant (PDA), a computer, a server, and a network device.

19. The article of manufacture of claim 17 wherein the data causing the machine to perform communicating comprises data that, when accessed by the machine, causes the machine to perform operations comprising:
receiving information on at least one of location, time, and velocity from the subscriber using global positioning system (GPS) information.

20. The article of manufacture of claim 17 wherein the data causing the machine to perform communicating further comprises data that, when accessed by the machine, causes the machine to perform operations comprising:
receiving a request for information for the traffic condition at the vicinity of the location via at least one of an automatic message, a verbal message, a textual message, and a visual message; and
transmitting the requested information to the subscriber via at least one of an automatic message, a verbal message, a textual message, and a visual message.

21. The article of manufacture of claim 17 wherein the data causing the machine to perform communicating comprises data that, when accessed by the machine, causes the machine to perform operations comprising:
receiving information for the traffic condition at the vicinity of the location via at least one of an automatic message, a verbal message, a textual message, and a visual message, the automatic message containing global positioning system (GPS) information.

22. The article of manufacture of claim 17 wherein the data further comprises data that, when accessed by the machine, causes the machine to perform operations comprising:
paying a compensation for the reported traffic condition.

23. The article of manufacture of claim 22 wherein the data causing the machine to perform paying the compensation comprises data that, when accessed by the machine, causes the machine to perform operations comprising:
paying the compensation being one of a credit for receiving information on the traffic condition, a payment, and a credit for a service.

24. The article of manufacture of claim 20 wherein the data further comprises data that, when accessed by the machine, causes the machine to perform operations comprising:
receiving a compensation for the requested information.

25. A system comprising:
a center having a central communication device; and
a plurality of subscribers traveling in vehicles, each of the subscribers establishing a connection to the central communication device using a subscriber communication device via a wireless connection, the subscriber communication device receiving global positional system (GPS) information, and communicating with the central communication device using the GPS information to report traffic condition at a vicinity of a location.

26. The system of claim 25 wherein each of the subscribers connects to the center using at least one of a cellular phone, a personal digital assistant (PDA), a computer, and a network device.

27. The system of claim 25 wherein each of the subscribers communicates with the center by:
transmitting information on at least one of location, time and velocity to the center using the GPS information.

28. The system of claim 25 wherein each of the subscribers communicates with the center by:
reporting the traffic condition at the vicinity of the location using at least one of an automatic message, a verbal message, a text message, and a visual message, the automatic message containing the GPS information.

29. The system of claim 25 wherein each of the subscribers communicates with the center by:
requesting information for the traffic condition at the vicinity of the location using at least one of an automatic message, a verbal message, a text message, and a visual message; and
receiving the requested information from the center via at least one of an automatic message, a verbal message, a text message, and a visual message.

30. The system of claim 27 wherein each of the subscribers receives a compensation for the reported traffic condition.

31. The system of claim 30 wherein each of the subscribers receives the compensation being one of a credit for receiving information on the traffic condition, a payment, and a credit for a service.

32. The system of claim 28 wherein each of the subscribers pays for the requested information.

33. The system of claim 25 wherein the center collects information regarding traffic conditions at different locations reported by the subscribers.

34. The system of claim 33 wherein the center analyzes the collected information to determine a traffic condition at a particular location.

35. The system of claim 33 wherein the center distributes the analyzed information to a subscriber when requested.

36. The system of claim 34 wherein the center distributes the analyzed information to a server of a traffic information center.

37. The system of claim 33 wherein the center posts the analyzed information on a Website.
